(19) United States
(12) Patent Application Publication
(10) Pub. No.: US 2007/0247089 A1
(43) Pub. Date: Oct. 25, 2007

(54) Lighting system and controller

(75) Inventor: David Thomas Summerland, Leiestershire (GB)

Correspondence Address: QUINE INTELLECTUAL PROPERTY LAW GROUP, P.C., P O BOX 458, ALAMEDA, CA, 94501, US

(73) Assignee: E Light Limited

(21) Appl. No.: 11/632,384

(22) PCT Filed: Jul. 11, 2005
(86) PCT No.: PCT/GB05/02745

§ 371 Date: Jan. 12, 2007

(30) Foreign Application Priority Data
Jul. 15, 2004 (GB) 0415794.7

(51) Int. Cl. H05B 37/02

(52) U.S. Cl. 315/308

(57) ABSTRACT

A lighting controller is used to independently control variable output intensity of both a first, relatively high power lighting unit and a second, relatively low power lighting unit. A control device is operable within an overall range of operation between first and second end points, for varying the light intensity output of both the first and second lighting units. The overall range of operation is divided into (i) a first range over which the intensity of the first lighting unit is varied between a first level and a second level and over which the intensity of the second lighting unit is held substantially constant at a third level, and (ii) a second range over which the intensity of the first lighting unit is held substantially constant at a fourth level and over which the intensity of the second lighting unit is varied between a fifth level and a sixth level.

The present invention relates to lighting systems, and in particular to lighting systems in which both relatively high power incandescent lighting units and more recent lower power solid state lighting units are installed.

Incandescent lighting units are used widely for internal lighting in buildings and other accommodation, in particular where dimmable lighting is required. More recently, solid state lighting units, such as those using light emitting diodes (LED's), have become popular for providing so-called ‘mood’ lighting. By providing three primary colors of light emitting diodes, it is readily possible to control an overall color of illumination from the LED lighting units by independently varying intensity of output from each one of the primary color groups.

It is widely recognised however that LED lighting units do not generally replace conventional incandescent and fluorescent lighting units as they are generally more expensive and relatively inefficient at producing high intensity white light. Therefore, LED lighting units are generally installed and used as an adjunct to conventional lighting.

LED lighting units require separate controls and switched mains supplies from standard lighting units so that the standard lighting can be turned off to allow the color changeable LED lighting to be used. Therefore, duplicate switches to allow full isolation of the individual lighting units, and dual controls for intensity and/or color, are also required.

Installation of separate wiring circuits and switching units for both incandescent lighting and for solid state lighting increases installation costs, especially where LED lighting is being added to an existing installed lighting system. In many domestic environments (e.g. small rooms such as kitchens, bedrooms and bathrooms), it is often considered aesthetically undesirable to provide multiple switch plates on walls for separate lighting controls.

It is an object of the present invention to provide a system that enables control of two such disparate lighting systems using a single control switch plate. It is a further object of the invention to provide a system that enables control of two such disparate lighting systems using a single existing wiring circuit. It is a further object of the invention to provide a system that enables -use of a unitary dimmer control switch for separate control of both incandescent and LED lighting.

Some or all of the above objects are provided by embodiments of the present invention as described hereinafter.

According to one aspect, the present invention provides a lighting controller for controlling light intensity, output of two different lighting systems, comprising:
a control device operable within an overall range of operation between first and second end points, for varying first and second electrical outputs as a function thereof,
in which the overall range is divided into (i) a first range over which the first electrical output is varied between a first power level and a second power level and over which the second electrical output is held substantially constant, and (ii) a second range over which the first electrical output is held substantially constant at a third power level and over which the second electrical output is varied between a first control level and a second control level.

According to another aspect, the present invention provides a lighting system comprising:
a first lighting unit and a second lighting unit of different electrical characteristics;
a control device operable within an overall range of operation between first and second end points, for varying the light intensity output of the first and second lighting units,
in which the overall range of operation is divided into (i) a first range over which the intensity of the first lighting unit is varied between a first level and a second level and over which the intensity and/or color characteristic of the second lighting unit is held substantially constant at a third level, and (ii) a second range over which the intensity of the first lighting unit is held substantially constant at a fourth level and over which the intensity and/or color characteristic of the second lighting unit is varied between a fifth level and a sixth level.

According to another aspect, the present invention provides a solid state lighting unit comprising:
an array of separately controllable light emitters of different colors adapted to provide a variable color characteristic output of the lighting unit; and
a control circuit for receiving a control input and for separately controlling the intensity of output of each of the different color light emitters in accordance with the control input;
wherein the control input is received on the main power supply to the lighting unit.

Embodiments of the present invention will now be described by way of example and with reference to the accompanying drawing in which:

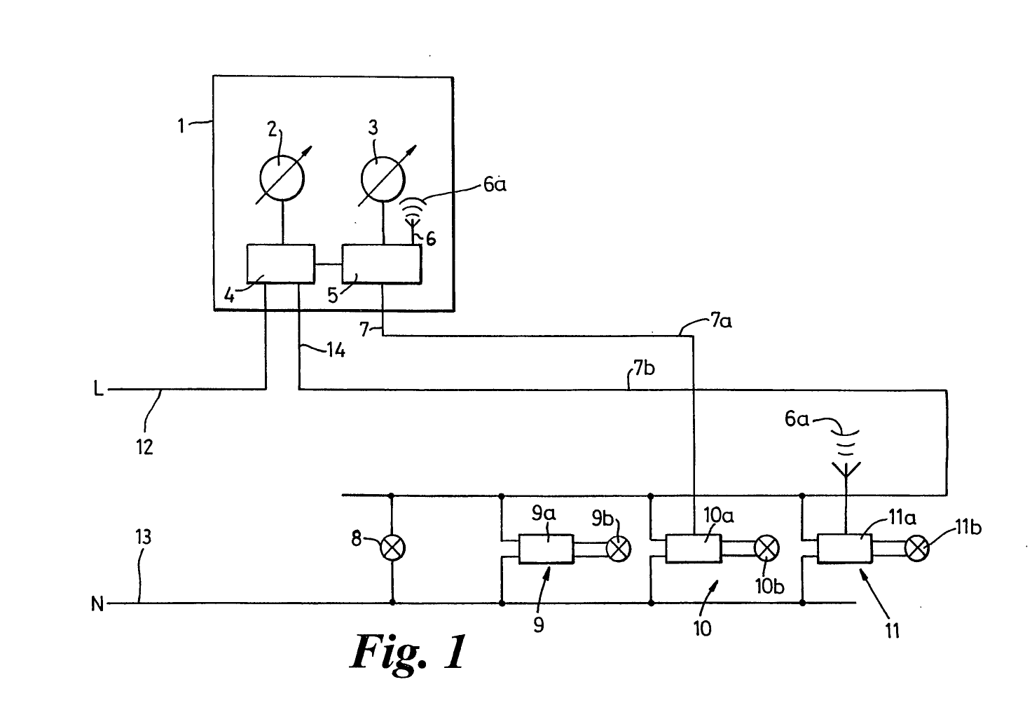

FIG. 1 is a schematic diagram of a lighting system according to a preferred arrangement.

With reference to FIG. 1, a wall switch plate 1 provides two rotary control knobs 2, 3 for providing variable control of respective outputs to be described hereinafter. The first knob 2 acts as a brightness or intensity control via a triac or thyristor dimming circuit 4, thus providing a phase-controlled, variable-power first electrical output on connection 14.

Preferably, the first knob 2 also incorporates an isolation switch (not shown) for isolating the electrical output 14, e.g. a push switch operated by pushing the rotary knob 2 on its axis, or a limit switch actuated by turning the knob to one extremity of its range, in accordance with known dimmer switch operation. When not isolated by the isolation switch, the dimming circuit 4 may also provide operating power to a control circuit 5 that provides a second electrical output 6 or 7 in the form of a first control signal to be described hereinafter.

The second knob 3 acts as a lighting color control via the control circuit 5 and via the second electrical output 6 or 7, in the form of a second control signal.

The wall switch plate 1 provides for connection of two or more lighting units 8 to 11 to a mains supply L, N. In the schematic of FIG. 1: lighting unit 8 is a mains voltage incandescent lighting unit; lighting unit 9 is a low voltage halogen lighting unit comprising transformer 9a and at least one low voltage bulb 9b; and lighting units 10 and 11 are color changeable LED units comprising respective control units 10a, 11a and LED arrays 10b, 11b.

The control circuit 5 of the switch plate 1 communicates with the solid state lighting units 10, 11 from the second electrical output 6 or 7 by way of a wired or wireless link. In the schematic of FIG. 1, three examples of control link are shown. In a first example, the control link comprises a hard wired connection 7a extending from second electrical output 7 to the lighting unit 10. In new installations, providing such a hard wired link is not usually problematic, and the wire 7a may form part of a local area network.

However, in other installations, it is desirable to use existing installed lighting circuits and an additional wire 7a is not used. In this instance, the control link may comprise a wireless control link 6a extending from the second electrical output 6 to the lighting unit 11. The wireless control link 6a may use any existing wireless communication technology in the electromagnetic or acoustic spectra, such as infra red, radio, and ultrasonic.

In a third configuration, mains-borne signalling may be used. In this arrangement, the control link 7b comprises the existing mains cable using mains signalling techniques, such as frequency modulation, amplitude modulation or phase modulation to transmit digital or analogue control signals to the control units 10a, 11a from the control circuit 5.

It will be understood that only one of the three types of control link exemplified in FIG. 1 need be used for any given switch plate 1. The control links 6a, 7a or 7b preferably use digital signalling techniques, although analogue signalling may also be used.

Operation of the preferred embodiments will now be described.

The two different lighting types—incandescent lighting units 8, 9 and LED lighting units 10, 11—have significantly different electrical characteristics. The first type of lighting systems have higher power requirements and are controllable in intensity by reducing the mains power that can be drawn by the lighting unit, conventionally by control of the voltage duty cycle of the mains supply. Preferably, this is done with phase-controlled variation in the voltage using a triac or thyristor dimming circuit.

The second type of (solid state) lighting systems have low power requirements, and the intensity of individual solid state devices, such as LED's, in a color array is generally controlled by pulse width modulation of a constant low voltage supply. The intensity of different color LED's within the array may be independently controlled in order to effect a change in the color characteristic output of the lighting system, or may be jointly controlled to effect a change in intensity only.

As such, it has been recognised that the second type of lighting system (e.g. units 10, 11) can continue to operate on only a very small fraction of the power requirements of the first type of lighting system (e.g. lighting units 8, 9). This means that the lighting units 10, 11 can continue to operate at full intensity even when the power available from the first electrical output 14 is at sufficiently low level that the light output from lighting units 8 and 9 is low, negligible or nil. By ‘negligible’, we mean that the light output is sufficiently small to have little or no practical effect on lighting a room in which the lighting unit 8, 9 is installed, such that the LED lighting units' output will dominate any lighting.

Thus, in this regime of operation of the lighting units 8, 9, the LED lighting units 10, 11 can still be intensity controlled (and therefore also color controlled) by way of conventional pulse width modulation techniques applied to the low voltage output of the controllers 10a, 11a.

In the preferred arrangement, dimmer switch 2 has an overall range of physical operation (e.g. approximately 360 degrees), which overall range of operation is divided into two ranges.

The first range of approximately half the overall range (i.e. approximately 180 degrees) is allocated to varying the voltage duty cycle of the first electrical output 14 between a high level corresponding to full brightness of the incandescent lamps 8, 9 and a low level corresponding to low, negligible or nil level of brightness of the incandescent lamps. In one example, the high level corresponds to a 100% power level and the low level corresponds to approximately 25% power level.

The second range, corresponding to the other half of the overall range (also approximately 180 degrees) is allocated to varying the first control signal on the second electrical output 6 or 7 between a first level, e.g. corresponding to full brightness of the LED lighting units and a second level, e.g. corresponding to a low, negligible or nil level of brightness of the LED lighting units. In this second range, the first electrical output is held at a level that is sufficient to maintain operation of the LED lighting units, but insufficient to maintain anything other than a low, negligible or nil light output of the incandescent lighting units. Control of the second electrical output 6 or 7 is effected by control circuit 5, which is preferably microprocessor-based.

Because the LED lighting units require a low voltage and low power supply, sufficient power can be extracted from the first electrical output during its ‘on’ phases even when the incandescent lighting cannot be supported. The control units 10a, 11a may include any necessary voltage/current converters and charge storage devices to enable (i) sufficient power to be extracted during the limited ‘on’ phases of the reduced power first electrical output, and (ii) proved the low voltage, pulse width modulation supply required to operate the LED lighting units.

Whilst the dinner switch 2 is in the first range, the first control signal on the second electrical output is held constant at a level which may correspond to full brightness of the LED lighting units, or may alternatively correspond to low, negligible or nil brightness of the LED lighting units. Because the LED lighting units are driven by local controllers 10a, 11a, these can be programmed to operate any suitable lighting level profile, e.g. one which has a linear or a non-linear transfer characteristic as a function of the first control signal provided by dimmer switch 2. Thus, while the dimmer switch 2 is operating through its first range, the first control signal may indicate to the local controller 10a, 11a that the LED lights should remain fully on, or fully off. When the dimmer switch is operating in the second range, the first control signal will vary to indicate that the intensity or color of output of the LED lighting units should vary according to a predetermined transfer characteristic.

In the preferred embodiment, the dinner switch 2 controls the intensity of the LED lighting system when in the second range, and the second rotary knob 3 is used to control the color or some other characteristic of the LED lighting system. In the case of a color control function, preferably one end point of the range of operation of the knob 3 corresponds to white light output, and this changes through colors of the rainbow as the knob is rotated through its range of operation to the other end point.

The second characteristic may be determined by a second control signal provided on the second electrical output 6, 7, i.e. multiplexed with the first control signal. In the case of digital control signals, this multiplexing may be achieved using time-multiplexed first and second control signal data packets or suitable code sequences encoding both first and second control signal levels. In the case of analogue control signals, the first and second control signals may occupy different channels using different modulation frequencies, for example.

A number of modifications may be made to the embodiments described in connection with FIG. 1.

The rotary knobs 2, 3 of the wall switch plate 1 may be slide controls or any other devices capable of providing continuous or quantised variable control over a range between two end points, e.g. separate ‘up’ and ‘down’ buttons providing incremental control between the end points. The control knobs or buttons may be provided on a battery powered remote control unit separate from the wall plate 1 or other housing containing the dimming control circuit 4 and control circuit 5.

Although the on/off switching function is preferably provided by a push switch or limit switch coupled to the rotary knob 2 as previously described, a separate switch may also be provided.

Multiple such control knobs may be provided on a single switch plate 1 for independent control of different lighting units. Further, multiple lighting units of the first and second types may be controlled by the same lighting controller.

The overall range of operation of the control device 2 may be allocated to the first and second ranges in different proportions than 50% each. Still further, while the first and second ranges are preferably coterminous, it will be understood that there may also be a small part of the overall range between the first and second ranges in which neither the first electrical output nor the second electrical output varies significantly or in which both the first and second electrical outputs vary.

Where independent control of only a single characteristic of the second lighting unit type is required (e.g. Color only, not intensity, or color and intensity but not independently), only a single dimmer switch 2 is required. In this instance, the first and second ranges of operation are as described, but the second range of operation is dedicated to varying the color and/or intensity according to a predetermined transfer characteristic. For example, the second range may correspond to change in color through the color spectrum, or may include a varying intensity white portion followed by a constant intensity but varying color portion.

Suitable ‘intelligence’ is preferably built into a microprocessor control unit in controllers 10a, 11a that these units can be preprogrammed with an appropriate response characteristic to varying control signal levels. In a still further embodiment, the controllers 10a, 11a may be preprogrammed to determine the color characteristic output of the lighting unit based on an amount of power available from the main power supply. In other words, the ‘control signal’ is effectively implied in the duty cycle of the main power supply to the LED lighting system.

In other words, the controller 10a, 11a receives the control signal for separately controlling the intensity of output of each of the different color light emitters from the main power supply to the lighting unit. While the mains duty cycle remains high (for controlling the incandescent lighting units on the same circuit), the controller makes no changes to the output of the LED lighting units. However, when the mains duty cycle is very short (so that any incandescent lighting units on the circuit have low, negligible or no output), the controller 10a, 11a varies the output characteristic of the LED lighting according to changing mains duty cycle.

Other embodiments are intentionally within the scope of the accompanying claims.

1. A lighting controller for controlling light intensity output of two different lighting systems, comprising:
a control device operable within an overall range of operation between first and second end points, for varying first and second electrical outputs as a function thereof,
in which the overall range is divided into (i) a first range over which the first electrical output is varied between a first power level and a second power level and over which the second electrical output is held substantially constant, and (ii) a second range over which the first electrical output is held substantially constant at a third power level and over which the second electrical output is varied between a first control level and a second control level.

2. The lighting controller according to claim 1 in which the first power level is a high power level, the second power level is a low power level, and the third power level is substantially the same as the second power level.

3. The lighting controller according to claim 2 in which the first power level corresponds to substantially 100% of mains voltage duty cycle and in which the second power level corresponds to a substantially reduced duty cycle.

4. The lighting controller according to claim 2, in which the second power level is sufficient to provide power for operation of a solid state lighting system but insufficient to provide power for operation of an incandescent lighting system.

5. The lighting controller according to claim 1, in which the first electrical output is a provided as a phase controller variable power output.

6. The lighting controller according to claim 5, in which the first electrical output comprises a triac and/or thyristor dimming circuit.

7. The lighting controller according to claim 1, in which the second electrical output is provided as an analogue of digital control signal variable between two levels.

8. The lightning controller according to claim 1, in which the second electrical output comprises a wireless output.

9. The lighting controller according to claim 7, in which the control signal is superimposed on the first electrical output.

10. The lighting controller according to claim 1, in which the control device includes a signal control knob slidable or rotatable between the first and second end points.

11. The lighting controller according to claim 1, in which the control device includes a pair of buttons respectively for incrementing and decrementing within the overall range of operation between the first and second end points.

12. The lighting controller according to claim 1, in which the first and second ranges each comprise approximately 50% of the overall range.

13. The lighting controller according to claim 10, in which the control knob or buttons are remotely located from power control elements of the controller, communicating therewith by wireless link.

14. The lighting controller according to claim 1, further including a second control device operable over a range of operating for varying a second control characteristic of the second electrical output.

15. A lighting system comprising:
a first lighting unit and a second lighting unit of different electrical characteristics;
a control device operable within an overall range of operation between first and second end points, for varying light intensity output of both the first and second lighting unit,
in which the overall range of operation is divided into (i) a first range over which the intensity of the first lighting unit is varied between a first level and a second level and over which the intensity and/or colorer characteristic of the second lighting unit is held substantially constant at a third level, and (ii) a second range over which the intensity of the first lighting unit is held substantially constant at a fourth level and over which the intensity and/or color characteristic of the second lighting unit is varied between a fifth level and sixth level.

16. The lighting system according to claim 15, in which the level is substantially full intensity and the second level is low intensity or off.

17. The lighting system according to claim 15, in which the fourth level is low intensity or off, the fifth level is substantially full intensity and the sixth level is low intensity or off.

18. The lighting system according to claim 15, in which the fifth level is substantially white light and the sixth level is colored light.

19. The lighting system according to claims 15, in which the control device communicates with the first lighting unit using the first and second power cables and communicates with the second lighting unit using said first and second power cables and a control channel.

20. The lighting system according to claim 19, in which the control channel is a separate wired link.

21. The lighting system according to claim 19, in which the control channel comprises mains-borne signalling on the first and/or second power cables.

22. The lighting system according to claim 19, in which the control channel comprises a wireless link.

23. The lighting system according to claim 15, in which the first lighting unit is an incandescent lighting unit and the second lighting unit is a solid state lighting unit.

24. The lighting system according to claims 19, in which the control device includes a phase-controlled variable power output for supplying the first and second lighting units and controlling the intensity of the first lighting unit.

25. The lighting system according to claim 24, in which the second lighting unit includes a decoder for determining intensity of the second lighting unit according to a control signal received over the control channel.

26. The lighting system according to claim 24, in which the second lighting unit includes a decoder for determining color characteristic of the second lighting unit according to a control signal received over the control channel.

27. The lighting system according to claim 15, in which the control device includes a signal control knob slidable or rotatable between the first and second endpoints.

28. The lighting system according to claim 15, in which the control device includes a pair of buttons respectively for incrementing and decrementing within the overall range of operation between the first and second end points.

29. The lighting system according to claim 15, in which the first and second ranges each comprises approximately 50% of the overall range.

30. The lighting system according to claim 28, in which the control know or buttons are remotely located from the power control elements of the controller, communicating therewith by wireless link.

31. The lighting system according to claim 19, further including a second control device operable over a range of operation for varying a second output characteristic of the second lighting unit.

32. The lighting system according to claim 31, in which the second characteristic is color.

33. The lighting system according to claim 31, in which the second output characteristic is varied by providing a second control signal, by the control device, to the second lighting unit over the control channel.

34. A solid state lighting unit comprising:
an array of separately controllable light emitters of different colors adapted to provide a variable color characteristic output of the lighting unit; and
a control circuit for receiving a control input and for separately controlling the intensity of output of each of the different color thigh emitters in accordance with the control input;
wherein the control input is received on the main power supply to the lighting unit.

35. The lighting unit according to claim 34, in which the control input comprises any one or more of a frequency modulation signal, an amplitude modulation signal, a phase modulation signal, or a power modulation signal received on the main power supply.

36. The lighting unit according to claim 34, in which the control circuit determines a color characteristic output of the lighting unit based on an amount of power available from the main power supply.

37. (canceled)
